(19) United States
(12) Patent Application Publication
(10) Pub. No.: US 2019/0235902 A1
(43) Pub. Date: Aug. 1, 2019

(54) BULLY VM DETECTION IN A HYPERCONVERGED SYSTEM

(71) Applicant: Nutanix, Inc., San Jose, CA (US)

(72) Inventors: Ribao Wei, San Mateo, CA (US); Abhinay Nagpal, Fremont, CA (US); Himanshu Shukla, San Jose, CA (US); Weiheng Chen, Seattle, WA (US); Cong Liu, San Jose, CA (US)

(21) Appl. No.: 15/884,727

(22) Filed: Jan. 31, 2018

(51) Int. Cl. G06F 9/455

(52) U.S. Cl. CPC G06F 9/45558; G06F 2009/45595; G06F 2009/45579

(57) ABSTRACT

An illustrative embodiment disclosed herein is a method by a data analytics chip, including finding a contention within a first predetermined amount of time, sorting user virtual machines based on consumption of each of the user virtual machines, and identifying a first subset of the user virtual machines. The first subset of the plurality of user virtual machines satisfies consumption criteria.

### BACKGROUND

A “virtual machine” or a “VM” refers to a specific software-based implementation of a machine in a virtualization environment, in which the hardware resources of a real computer (e.g., CPU, memory, etc.) are virtualized or transformed into the underlying support for the fully functional virtual machine that can run its own operating system and applications on the underlying physical resources just like a real computer.

Further details of aspects, objects, and advantages of the invention are described below in the detailed description, drawings, and claims. Both the foregoing general description and the following detailed description are exemplary and explanatory, and are not intended to be limiting as to the scope of the invention. Particular embodiments may include all, some, or none of the components, elements, features, functions, operations, or steps of the embodiments disclosed above. The subject matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### SUMMARY OF PARTICULAR EMBODIMENTS

Aspects of the present disclosure relate generally to a virtualization environment, and more particularly to a method, by a data analytics chip, of detecting bully VMs in a hyperconverged environment. One technical advantage of the foregoing disclosure is that reducing IO contentions results in user VMs having reduced IO latency and increased IO request throughput. Another technical advantage of the foregoing disclosure is that reducing CPU contentions caused by IO contentions results in user VMs having lower wait times to be scheduled to use a physical CPU core.

An illustrative embodiment disclosed herein is a method by a data analytics chip, including finding a contention within a first predetermined amount of time, sorting user virtual machines based on consumption of each of user virtual machines, and identifying a first subset of the user virtual machines. The first subset of the user virtual machines satisfies some consumption criteria.

Another illustrative embodiment disclosed herein is a system including a plurality of user virtual machines, a controller virtual machine coupled to the user virtual machines, and a data analytics chip. The data analytics chip finds a contention within a first predetermined amount of time, sorts user virtual machines based on consumption of each of the user virtual machines, and identifies a first subset of the user virtual machines. The first subset of the user virtual machines satisfies some consumption criteria.

Another illustrative embodiment disclosed herein is a non-transitory computer-readable storage medium having instructions stored thereon that, upon execution by a computing device, causes the computing device to perform operations including finding a contention within a first predetermined amount of time, sorting user virtual machines based on consumption of each of user virtual machines, and identifying a first subset of the user virtual machines. The first subset of the user virtual machines satisfies some consumption criteria.

Further details of aspects, objects, and advantages of the invention are described below in the detailed description, drawings, and claims. Both the foregoing general description and the following detailed description are exemplary and explanatory, and are not intended to be limiting as to the scope of the invention. Particular embodiments may include all, some, or none of the components, elements, features, functions, operations, or steps of the embodiments disclosed above. The subject matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1A illustrates a hyperconverged clustered virtualization environment.

FIG. 1B illustrates data flow within a hyperconverged clustered virtualization environment.

FIG. 2 illustrates operations performed in an example method of detecting a bully VM.

FIG. 3 illustrates a block diagram of a computing system suitable for implementing particular embodiments disclosed herein.

The foregoing and other features of the present disclosure will become apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

### DESCRIPTION OF EXAMPLE EMBODIMENTS

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

A bully virtual machine (VM) is a user VM that is consuming such a large amount of resources that it causes contentions, thereby affecting other user VMs. In conventional embodiments, bully VMs cause CPU and memory resource contention, but not IO contention because the user VMs on the server make an IO request, and separately sold storage boxes serve requests by the VMs on the server. Because the separately sold storage boxes are spread out, service of requests do not converge at any one point. Conventional bully VM detection methods work accordingly. However, traditional data center architecture also suffer from not being able to scale linearly, not being able to share resources, and the like. A new architecture using a hyperconverged, virtualized environment has a controller virtual machine (CVM) serves the IO requests and resides on the same node where user VMs make requests.

However, with the advent of the virtualized, hyperconverged environment, bully VMs affect user VMs via IO contention. A bully VM makes a large amount of IO requests. The CVM serves all the bully VM requests and fetches data from a storage tier. As a bully VM continues to make a large number of IO requests, the likelihood the CVM CPU usage is 100% greatly increases. Once CVM CPU usage is 100%, an IO contention occurs. Accordingly, one technical problem is that, as a result of IO contention, user VMs have increased IO latency and reduced IO request throughput. Furthermore, an IO contention may lead to a CPU contention because the user VMs which are on the same node as the CVM are competing with the CVM for the same CPU resource. Accordingly, another technical problem is that the CPU contention results in an increase of CPU ready times for the affected user VMs, meaning the user VM has to wait longer to be scheduled to use a physical CPU core. The reduced IO latency, reduced throughput, and increased CPU ready times of the user VMs make the data center less desirable for deploying mission-critical workloads.

This disclosure is directed towards a method, by a data analytics chip, of detecting bully VMs in a hyperconverged environment. The data analytics chip finds contentions, including CPU, memory, and IO contentions. Then the data analytics chip sorts all user VMs based on their consumption metric. Then the data analytics identifies a subset of user VMs that meet certain consumption criteria. This sorting and identifying can be done once or periodically. If done once, the members of the subset are deemed bully VMs. If done periodically, then consistent offenders, or user VMs which appear in multiple subsets, are deemed bully VMs. One technical advantage of the foregoing disclosure is that reducing IO contentions results in user VMs having reduced IO latency and increased IO request throughput. Another technical advantage of the foregoing disclosure is that reducing CPU contentions caused by IO contentions results in user VMs having lower wait times to be scheduled to use a physical CPU core.

Virtualization works by inserting a thin layer of software directly on the computer hardware or on a host operating system. This layer of software contains a virtual machine monitor or “hypervisor” that allocates hardware resources dynamically and transparently. Multiple operating systems run concurrently on a single physical computer and share hardware resources with each other. By encapsulating an entire machine, including CPU, memory, operating system, and network devices, a virtual machine is completely compatible with most standard operating systems, applications, and device drivers. Most modern implementations allow several operating systems and applications to safely run at the same time on a single computer, with each having access to the resources it needs when it needs them.

Virtualization allows one to run multiple virtual machines on a single physical machine, with each virtual machine sharing the resources of that one physical computer across multiple environments. Different virtual machines can run different operating systems and multiple applications on the same physical computer.

One reason for the broad adoption of virtualization in modern business and computing environments is because of the resource utilization advantages provided by virtual machines. Without virtualization, if a physical machine is limited to a single dedicated operating system, then during periods of inactivity by the dedicated operating system the physical machine is not utilized to perform useful work. This is wasteful and inefficient if there are users on other physical machines which are currently waiting for computing resources. To address this problem, virtualization allows multiple VMs to share the underlying physical resources so that during periods of inactivity by one VM, other VMs can take advantage of the resource availability to process workloads. This can produce great efficiencies for the utilization of physical devices, and can result in reduced redundancies and better resource cost management.

Furthermore, there are now products that can aggregate multiple physical machines, running virtualization environments to not only utilize the processing power of the physical devices to aggregate the storage of the individual physical devices to create a logical storage pool wherein the data may be distributed across the physical devices but appears to the virtual machines to be part of the system that the virtual machine is hosted on. Such systems operate under the covers by using metadata, which may be distributed and replicated any number of times across the system, to locate the indicated data. These systems are commonly referred to as clustered systems, wherein the resources of the group are pooled to provide logically combined, but physically separate systems.

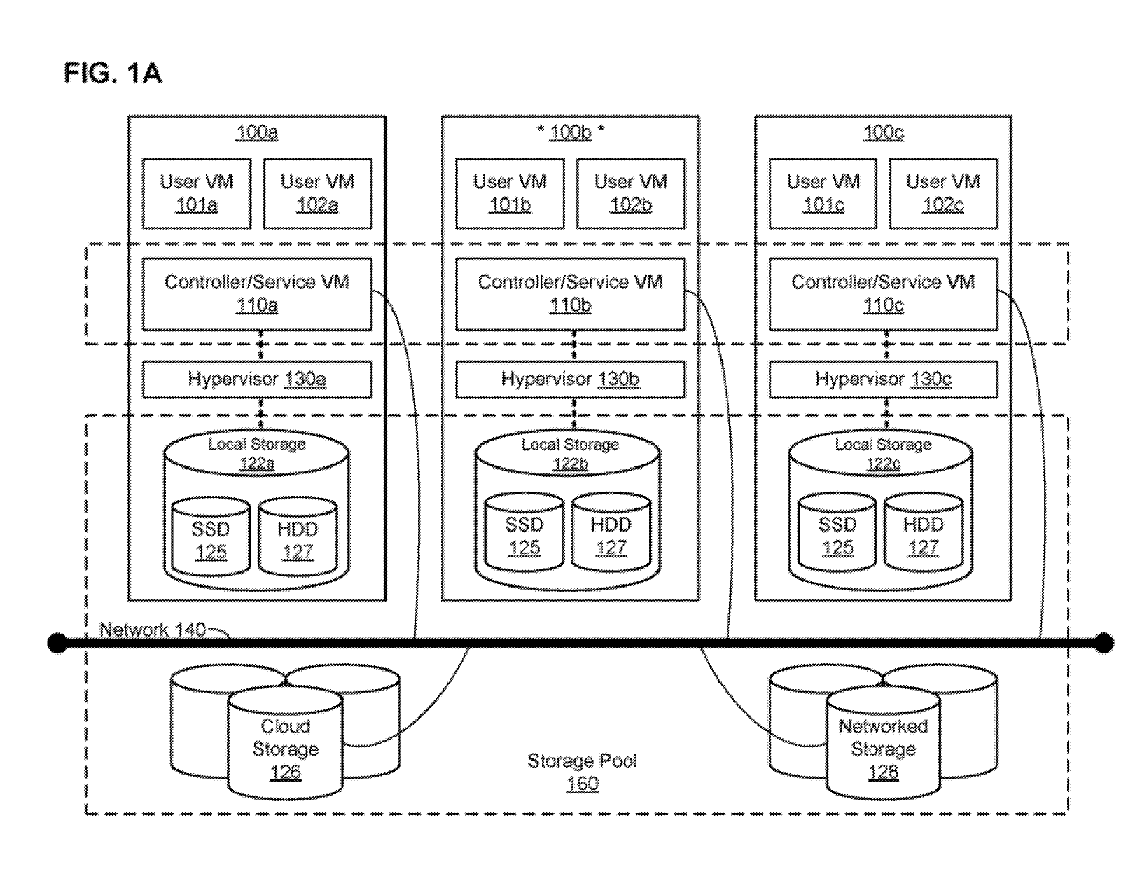

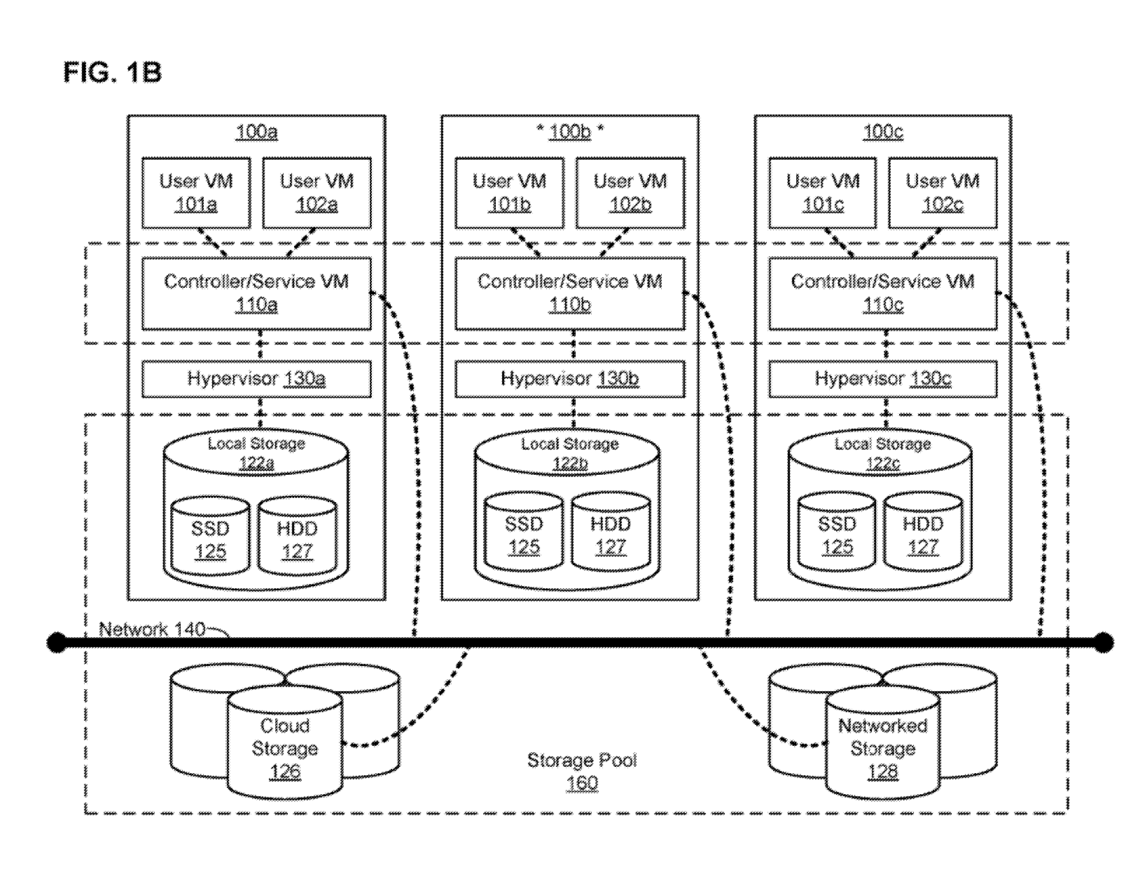

FIG. 1A illustrates a hyperconverged clustered virtualization environment according to particular embodiments. The architecture of FIG. 1A can be implemented for a distributed platform that contains multiple host machines 100a-c that manage multiple tiers of storage. The multiple tiers of storage may include network-attached storage (NAS) that is accessible through network 140, such as, by way of example and not limitation, cloud storage 126, which may be accessible through the Internet, or local network-accessible storage 128 (e.g., a storage area network (SAN)). Unlike the prior art, the present embodiment also permits local storage 122a-c that is within or directly attached to the server and/or appliance to be managed as part of storage pool 160. Examples of such storage include Solid State Drives 125 (henceforth “SSDs”), Hard Disk Drives 127 (henceforth “HDDs” or “spindle drives”), optical disk drives, external drives (e.g., a storage device connected to a host machine via a native drive interface or a direct attach serial interface), or any other directly attached storage. These collected storage devices, both local and networked, form storage pool 160. Virtual disks (or “vDisks”) can be structured from the storage devices in storage pool 160, as described in more detail below. As used herein, the term vDisk refers to the storage abstraction that is exposed by a Controller/Service VM (CVM) 110 to be used by a user VM. In some embodiments, the vDisk is exposed via iSCSI (“internet small computer system interface”) or NFS (“network file system”) and is mounted as a virtual disk on the user VM.

Each host machine 100a-c runs virtualization software, such as VMWARE ESX(I), MICROSOFT HYPER-V, or REDHAT KVM. The virtualization software includes hypervisor 130a-c to manage the interactions between the underlying hardware and the one or more user VMs 101a, 102a, 101b, 102b, 101c, and 102c that run client software. Though not depicted in FIG. 1A, a hypervisor may connect to network 140. In particular embodiments, a host machine 100 may be a physical hardware computing device; in particular embodiments, a host machine 100 may be a virtual machine.

CVMs 110a-c are used to manage storage and input/output (“I/O”) activities according to particular embodiments. These special VMs act as the storage controller in the currently described architecture. Multiple such storage controllers may coordinate within a cluster to form a unified storage controller system. CVMs 110 may run as virtual machines on the various host machines 100, and work together to form a distributed system 110 that manages all the storage resources, including local storage 122, networked storage 128, and cloud storage 126. The CVMs may connect to network 140 directly, or via a hypervisor. Since the CVMs run independent of hypervisors 130a-c, this means that the current approach can be used and implemented within any virtual machine architecture, since the CVMs of particular embodiments can be used in conjunction with any hypervisor from any virtualization vendor.

A host machine may be designated as a leader node within a cluster of host machines. For example, host machine 100b, as indicated by the asterisks, may be a leader node. A leader node may have a software component designated to perform operations of the leader. For example, CVM 110b on host machine 100b may be designated to perform such operations. A leader may be responsible for monitoring or handling requests from other host machines or software components on other host machines throughout the virtualized environment. If a leader fails, a new leader may be designated. In particular embodiments, a management module (e.g., in the form of an agent) may be running on the leader node.

Each CVM 110a-c exports one or more block devices or NFS server targets that appear as disks to user VMs 101a-c and 102a-c. These disks are virtual, since they are implemented by the software running inside CVMs 110a-c. Thus, to user VMs 101a-c and 102a-c, CVMs 110a-c appear to be exporting a clustered storage appliance that contains some disks. All user data (including the operating system) in the user VMs 101a-c and 102a-c reside on these virtual disks.

Significant performance advantages can be gained by allowing the virtualization system to access and utilize local storage 122 as disclosed herein. This is because I/O performance is typically much faster when performing access to local storage 122 as compared to performing access to networked storage 128 across a network 140. This faster performance for locally attached storage 122 can be increased even further by using certain types of optimized local storage devices, such as SSDs. Further details regarding methods and mechanisms for implementing the virtualization environment illustrated in FIG. 1A are described in U.S. Pat. No. 8,601,473, which is hereby incorporated by reference in its entirety.

FIG. 1B illustrates data flow within an example hyperconverged clustered virtualization environment according to particular embodiments. As described above, one or more user VMs and a CVM may run on each host machine 100 along with a hypervisor. As a user VM performs I/O operations (e.g., a read operation or a write operation), the I/O commands of the user VM may be sent to the hypervisor that shares the same server as the user VM. For example, the hypervisor may present to the virtual machines an emulated storage controller, receive an I/O command and facilitate the performance of the I/O command (e.g., via interfacing with storage that is the object of the command, or passing the command to a service that will perform the I/O command). An emulated storage controller may facilitate I/O operations between a user VM and a vDisk. A vDisk may present to a user VM as one or more discrete storage drives, but each vDisk may correspond to any part of one or more drives within storage pool 160. Additionally or alternatively, CVM 110a-c may present an emulated storage controller either to the hypervisor or to user VMs to facilitate I/O operations. CVM 110a-c may be connected to storage within storage pool 160. CVM 110a may have the ability to perform I/O operations using local storage 122a within the same host machine 100a, by connecting via network 140 to cloud storage 126 or networked storage 128, or by connecting via network 140 to local storage 122b-c within another host machine 100b-c (e.g., via connecting to another CVM 110b or 110c). In particular embodiments, any suitable computing system 300 may be used to implement a host machine 100.

Bully VM detection is implemented in a hyperconverged clustered virtualization environment (for example, FIG. 1A). In some embodiments, a data analytics chip is configured to detect bully VMs. The data analytics chip resides inside a physical node (for example, the physical node 100a in FIG. A). In other embodiments, the data analytics chip is implemented as a process running on the controller virtual machine, or CVM (for example, the CVM 110a in FIG. 1A).

In a first step, the data analytics chip monitors three types of contentions. The first is CPU contention. In some embodiments, a user VM's virtual CPU (vCPU) ready time is an indicator for CPU contention. In further embodiments, if there is at least one VM that has per vCPU ready time greater than 5%, a node on which the affected VM resides is defined as a node with CPU contention. When there is CPU contention, the data analytics chip monitors CPU consumption of all user VMs residing on the node. In some embodiments, the user VM's CPU consumption is defined as the user VM's virtual CPU (vCPU) usage multiplied by the number of vCPU, or the number of physical CPU cores available to the user VM.

Another type of contention is memory contention. In some embodiments, if there is a node with at least one VM for which the memory swap rate greater than the pre-determined value for a given time interval, then there is memory contention on this node. In further embodiments, the pre-determined value is zero. When there is the memory contention, the data analytics chip monitors memory consumption of all user VMs residing on the node. In some embodiments, memory usage is the measurement for the user VM's memory consumption.

Another type of contention is IO contention. The IO contention is identified by a high CVM CPU usage. A CVM serves a request by using metadata lookup to determine which storage tier the data is residing on. The storage tiers comprise RAM in cache, SSD, and HDD. Then the CVM fetches the data. In some embodiments, high CVM IO usage indicates that the IO contention is occurring during the service of the request because of reads and writes made during metadata lookup. In other embodiments, a large queue length (also known as a queue buildup) on the storage device indicates that the IO contention is happening during fetching of the data and is due to the storage tier being slow. In some embodiments, if the tier on which the data resides is cache or SSD, then it is more likely that the IO contention is happening during the service of the request. In some embodiments, spikes of read or write delay, or total throughput versus expected maximum throughput could be used to determine whether there is IO contention.

Once the IO contention is discovered, it can be traced back to a user VM. In some embodiments, the data analytics chip reports the CVM CPU usage on a per vDisk. Every disk can have multiple vDisks. The CVM is doing IO on those vDisks. In further embodiments, the data analytics chip determines which vDisk is consuming the most CVM CPU time. Based on that, the data analytics chip determines which user VM is consuming the most CVM CPU time. In some embodiments, if the IO contention is happening because of a large queue buildup, the data analytics chip determines which user VM is causing the queue buildup. There is a mapping between vDisks and user VMs.

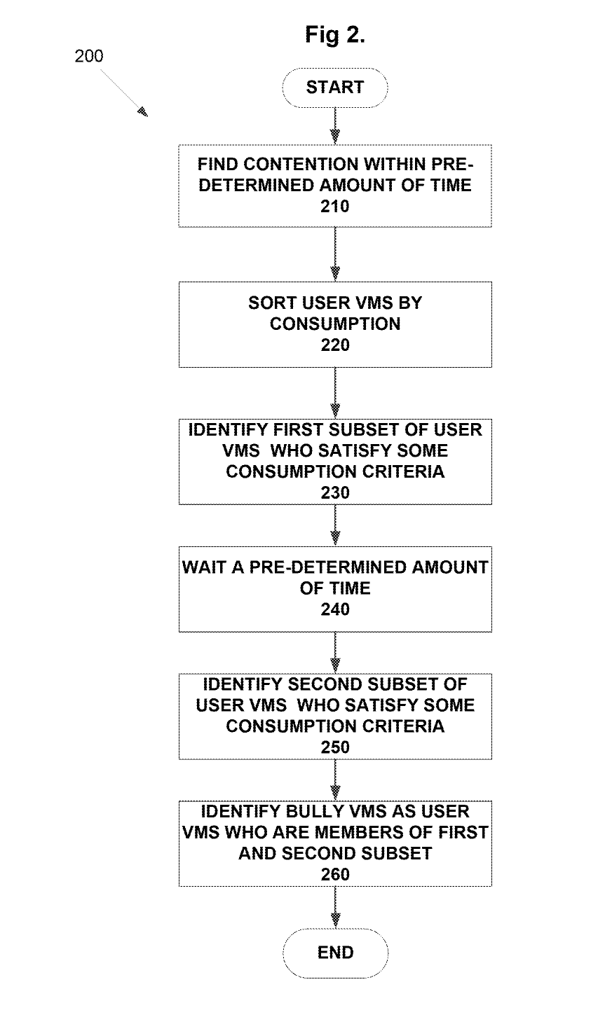

FIG. 2 illustrates operations performed in an example method of detecting a bully VM. Additional, fewer, or different operations may be performed depending on the embodiment. At operation 210, the data analytics chip finds a contention. In some embodiments, contention is found by monitoring vCPU ready times, memory swap rate, memory usage, and the CVM CPU usage, as described above. These parameters can be checked at periodic times to see if any of the parameters have exceeded a pre-determined threshold, in which case, a contention event has occurred. At operation 220, the data analytics chip sorts the user VMs by their consumption of a resource. CVMs are excluded from the sort because CVMs are not making IO requests. In some embodiments, the consumption is quantified as the vCPU usage of a particular user VM multiplied by the number of physical cores available to the user VM. In further embodiments, the data analytics chip on a node receives the vCPU usage of each VM on the node from the hypervisor on the node. In some embodiments, the consumption is reported as a percentage.

At operation 230, the data analytics chip identifies a subset of user VMs that satisfies some consumption criteria. In some embodiments, bully VMs are characterized as a minority of user VMs, with their consumptions being significantly more than the rest of user VMs. In some embodiments, the subset consumes at least 30% of total consumptions of all user VMs. In other embodiments, the size of the group is no more than some predetermined size threshold. In further embodiments, the pre-determined size threshold is the least of 5% and 20% of the total number of VMs. In some embodiments, the difference in consumption between two neighboring user VMs in the subset should not be more than 10%. In some embodiments, the consumption difference between the last user VM in the subset (meaning the user VM in the subset with the lowest consumption percentage among all members of the subset) and the first user VM outside the subset (meaning the user VM not in the subset with the highest consumption percentage among all user VMs not in the subset) should be at least 10%.

At operation 240, the data analytics chip waits a pre-determined amount of time. At operation 250, the data analytics chip identifies a second subset of user VMs based on consumption criteria. At operation 260, the data analytics chip identifies as bully VMs any user VMs which are members of the first subset and the second subset. In some embodiments, bully VMs are characterized as repeat offenders of high consumption. For example, a bully VM meets consumption criteria, and thus, is a cause to contentions, for more than 30 minutes during a 24 hour period.

In another example method of bully VM detection which is not shown, only operation steps 210, 220, and 230 of the previous example are performed. Then in another step not shown, the bully VMs are identified as the members of the first subset of user VMs.

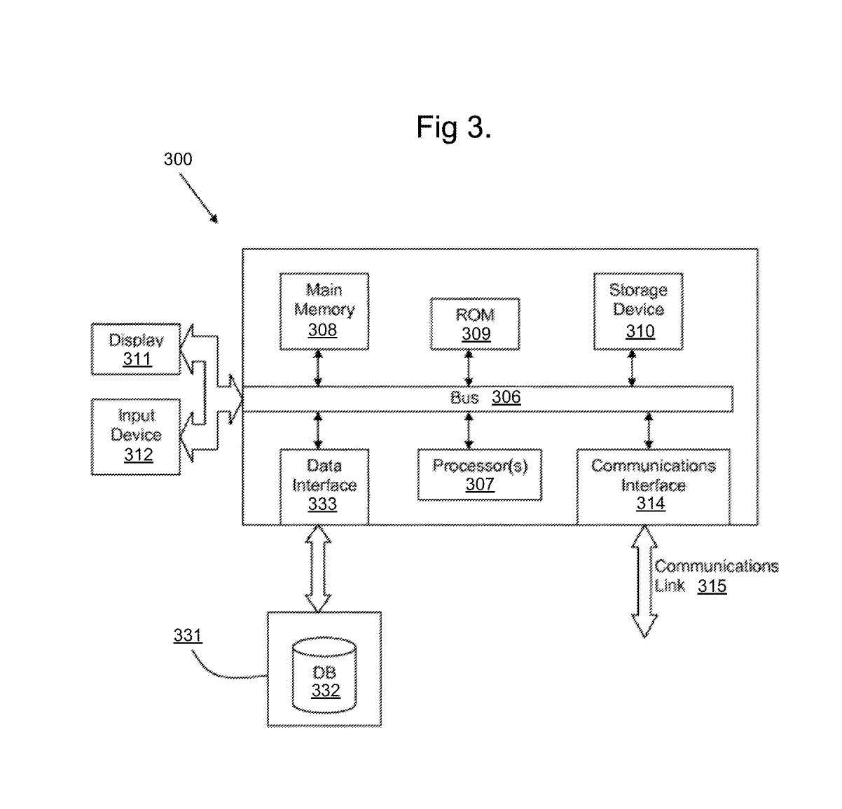

FIG. 3 illustrates a computer system 300 that includes a bus 306 (e.g., an address bus and a data bus) or other communication mechanism for communicating information, which interconnects subsystems and devices, such as processor 307, system memory 308 (e.g., RAM), static storage device 309 (e.g., ROM), disk drive 310 (e.g., magnetic or optical), communication interface 314 (e.g., modem, Ethernet card, a network interface controller (NIC) or network adapter for communicating with an Ethernet or other wire-based network, a wireless NIC (WNIC) or wireless adapter for communicating with a wireless network, such as a WI-FI network), display 311 (e.g., CRT, LCD, LED), input device 312 (e.g., keyboard, keypad, mouse, microphone). In particular embodiments, computer system 300 may include one or more of any such components.

According to one embodiment of the disclosure, computer system 300 performs specific operations by processor 307 executing one or more sequences of one or more instructions contained in system memory 308. Such instructions may be read into system memory 308 from another computer readable/usable medium, such as static storage device 309 or disk drive 310. In alternative embodiments, hard-wired circuitry may be used in place of or in combination with software instructions. Thus, particular embodiments are not limited to any specific combination of hardware circuitry and/or software. In one embodiment, the term “logic” shall mean any combination of software or hardware.

The term “computer readable medium” or “computer usable medium” as used herein refers to any medium that participates in providing instructions to processor 307 for execution. Such a medium may take many forms, including but not limited to, nonvolatile media and volatile media. Non-volatile media includes, for example, optical or magnetic disks, such as disk drive 310. Volatile media includes dynamic memory, such as system memory 308.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

In particular embodiments, execution of the sequences of instructions is performed by a single computer system 300. According to other embodiments, two or more computer systems 300 coupled by communication link 315 (e.g., LAN, PTSN, or wireless network) may perform the sequence of instructions in coordination with one another.

Computer system 300 may transmit and receive messages, data, and instructions, including program, i.e., application code, through communication link 315 and communication interface 314. Received program code may be executed by processor 307 as it is received, and/or stored in disk drive 310, or other non-volatile storage for later execution. A database 332 in a storage medium 331 may be used to store data accessible by the system 300 by way of data interface 333.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

1. A computer-implemented method comprising:
finding a contention associated with a controller virtual machine within a first predetermined amount of time;
sorting a plurality of user virtual machines coupled to the controller virtual machine, wherein sorting the plurality of user virtual machines is based on consumption of each of the plurality of user virtual machines; and
identifying a first subset of the plurality of user virtual machines, the first subset of the plurality of user virtual machines satisfies consumption criteria.

2. The method of claim 1, further comprising:
delaying a second pre-determined amount of time;
identifying a second subset of the plurality of user virtual machines, the second subset of the plurality of user virtual machines; and
identifying a plurality of bully VMs, the plurality of bully VMs being members of the first subset of the plurality of user virtual machines and the second subset of the plurality of user virtual machines.

3. The method of claim 1, further comprising identifying a plurality of bully VMs, the plurality of bully VMs being member of the first subset of the plurality of user virtual machines.

4. The method of claim 1, wherein the contention is an input output (I/O) contention.

5. The method of claim 1, wherein finding the contention is based on a central processing unit (CPU) usage of the controller virtual machine.

6. The method of claim 1, wherein the consumption criteria comprises an actual size of the first subset of the plurality of user virtual machines being no more than a predetermined size.

7. (canceled)

8. The method of claim 1, wherein the consumption criteria comprises a first consumption difference between two neighboring user virtual machines in the first subset of the plurality of user virtual machines, the first consumption difference not being more than a first predetermined threshold.

9. The method of claim 1, wherein the consumption criteria comprises a second consumption difference between a last user virtual machine in the first subset of the plurality of user virtual machines and a user first virtual machine outside the first subset of the plurality of user virtual machines, the second consumption difference being at least a second predetermined threshold.

10. An apparatus comprising a processor having programmed instructions to find a contention associated with a controller virtual machine within a first predetermined amount of time;
sort a plurality of user virtual machines coupled to the controller virtual machine, wherein sorting the plurality of user virtual machines is based on consumption of each of the plurality of user virtual machines; and
identify a first subset of the plurality of user virtual machines, the first subset of the plurality of user virtual machines satisfies consumption criteria.

11. The apparatus of claim 10, wherein the processor further has programmed instructions to:
delay a second pre-determined amount of time;
identify a second subset of the plurality of user virtual machines, the second subset of the plurality of user virtual machines; and
identify a plurality of bully VMs, the plurality of bully VMs being members of the first subset of the plurality of user virtual machines and the second subset of the plurality of user virtual machines.

12. The apparatus of claim 10, wherein the processor further has programmed instructions to identify a plurality of bully VMs, the plurality of bully VMs being member of the first subset of the plurality of user virtual machines.

13. The apparatus of claim 10, wherein the contention is an input/output (IO) contention.

14. The apparatus of claim 10, wherein finding the contention is based on a central processing unit (CPU) usage of the controller virtual machine.

15. The apparatus of claim 10, wherein the consumption criteria comprises an actual size of the first subset of the plurality of user virtual machines being no more than a predetermined size.

16. (canceled)

17. The apparatus of claim 10, wherein the consumption criteria comprises a first consumption difference between two neighboring user virtual machines in the first subset of the plurality of user virtual machines, the first consumption difference not being more than a first predetermined threshold.

18. The apparatus of claim 10, wherein the consumption criteria comprises a second consumption difference between a last user virtual machine in the first subset of the plurality of user virtual machines and a first user virtual machine outside the first subset of the plurality of user virtual machines, the second consumption difference being at least a second predetermined threshold.

19. A non-transitory computer-readable storage medium having instructions stored thereon that, upon execution by a processor, causes the processor to perform operations comprising:
finding a contention associated with a controller virtual machine within a first predetermined amount of time;
sorting a plurality of user virtual machines coupled to the controller virtual machine, wherein sorting the plurality of user virtual machines is based on consumption of each of the plurality of user virtual machines; and
identifying a first subset of the plurality of user virtual machines, the first subset of the plurality of user virtual machines satisfies consumption criteria.

20. The non-transitory computer-readable storage medium of claim 19, the operations further comprising:
delaying a second pre-determined amount of time;
identifying a second subset of the plurality of user virtual machines, the second subset of the plurality of user virtual machines; and
identifying a plurality of bully VMs, the plurality of bully VMs being members of the first subset of the plurality of user virtual machines and the second subset of the plurality of user virtual machines.

21. The non-transitory computer-readable storage medium of claim 19, the operations further comprising identifying a plurality of bully VMs, the plurality of bully VMs being member of the first subset of the plurality of user virtual machines.

22. The non-transitory computer-readable storage medium of claim 19, wherein the contention is an input output (I/O) contention.

23. The non-transitory computer-readable storage medium of claim 19, wherein finding the contention is based on a central processing unit (CPU) usage of the controller virtual machine.

24. The non-transitory computer-readable storage medium of claim 19, wherein the consumption criteria comprises an actual size of the first subset of the plurality of user virtual machines being no more than a predetermined size.

25. The non-transitory computer-readable storage medium of claim 19, wherein the consumption criteria comprises a first consumption difference between two neighboring user virtual machines in the first subset of the plurality of user virtual machines, the first consumption difference not being more than a first predetermined threshold.

26. The non-transitory computer-readable storage medium of claim 19, wherein the consumption criteria comprises a second consumption difference between a last user virtual machine in the first subset of the plurality of user virtual machines and a user first virtual machine outside the first subset of the plurality of user virtual machines, the second consumption difference being at least a second predetermined threshold.
